(19) United States
(12) Patent Application Publication
(10) Pub. No.: US 2023/0029281 A1
(43) Pub. Date: Jan. 26, 2023

(54) FASTENING APPARATUS FOR FASTENING A VENTILATOR TO A CARRIER STRUCTURE

(71) Applicant: ebm-papst Mulfingen GmbH & Co. KG, Mulfingen (DE)

(72) Inventors: Harald ALLERSTORFER, Bad Mergentheim (DE); Christoph CARLE, Forchtenberg (DE)

(73) Assignee: ebm-papst Mulfingen GmbH & Co. KG, Mulfingen (DE)

(21) Appl. No.: 17/622,423

(22) PCT Filed: Jun. 17, 2020
(86) PCT No.: PCT/EP2020/066726

§ 371 Date: Oct. 6, 2022

(30) Foreign Application Priority Data
Jul. 22, 2019 (DE) 10 2019 119 750.3

(51) Int. Cl. F04D 29/62; F04D 25/08; F04D 29/42

(52) U.S. Cl. CPC F04D 29/626; F04D 25/08; F04D 29/4226

(57) ABSTRACT

The invention relates to a fastening apparatus (1) for fastening a ventilator (2) to a carrier structure, having—at least two support elements (3a, 3b), each being connectable at the first end (4) thereof to the carrier structure, wherein at least two of the support elements (3a, 3b) have a fastening means (5) for fastening a ventilator (2), wherein—the support elements (3a, 3b) are connected at the second end (7) thereof to the adjacent support element (3a, 3b), such that the support elements (3a, 3b) mutually support each other, wherein—the fastening means (5) is spaced apart from a connection point (17), at which the second end (7) is connected to the adjacent support element (3a, 3b).

### FIELD

The present disclosure relates to a fastening device to fastening a fan to a carrier structure, and it also relates to a ventilation system.

### SUMMARY

During the operation of motor-driven fans, a fastening device must be provided that is suitable for the intended use in order to correctly position and align the fan for that application. Typically, a fan is attached to a carrier structure, that can be formed by a duct, for example.

In addition to the positioning and aligning the fan, the fastening device ensures reliable operation by absorbing the forces occurring during operation of the fan without the occurrence of vibrations.

Furthermore, the fastening device must not impair the flow behavior of the fan, or it may do so only slightly. The aim is for a cross-sectional area of the fastening device to be as small as possible so that the air flowing in and out is not adversely affected.

To address this problem, in DE 10 2012 004 617 A1 the fan is suspended by two integrally formed struts with a fastening part in the middle. The fastening part is, in turn, fastened to a fastening block of the motor. In addition, a further support part is provided that is also fastened to the fastening block for further stabilization.

DE 20 2006 013 442 U1 connects a carrier structure to a fan by four pairs of struts that hold the fan on a fastening flange. The struts are connected at their end to the fastening flange of the fan.

CN 208702754 U discloses the attachment of a fan to a carrier structure by struts. In this case, four struts are provided. The struts, starting from a ring element, extend radially outward in order to be fastened to the carrier structure. The motor of the fan has fastening elements that can be fastened to the ring element.

It is an object of the present disclosure to provide a fastening device that improves stability with reduced weight. It is also an object of the disclosure to provide a ventilation system with improved stability and reduced weight. The disclosure achieves this object according to a fastening device for fastening a fan to a carrier structure, that comprises at least two support elements. Each of the at least two support elements can be connected at its first end to the carrier structure. The at least two support elements have a fastener for fastening a fan. The support elements are connected at their second end to the adjacent support element. Thus, the support elements support one another, the fasteners are spaced apart from a connection point where the second end is connected to the adjacent support element, the support element has two legs that are arranged substantially at right angles to one another. The support element is formed from a planar element with a base surface, a carrier section of the first leg angled relative to the base surface, and a support section of the second leg angled relative to the base surface. A ventilation system comprises a fan and a fastening device for fastening the fan to a carrier structure as set forth. A drive motor of the fan is connected to the fastening device via a motor flange.

According to the disclosure, a fastening device for fastening a fan to a carrier structure comprises at least two support elements. Each element can be connected at its first end to the carrier structure. At least two of the support elements have a fastener for fastening a fan. The support elements are connected at their second end to the adjacent support element. Thus, the support elements support one another. The fastener is spaced apart from a connection point where the second end is connected to the adjacent support element.

By virtue of the connection of the support elements, they stabilize one another without the need for an additional component to stabilize the fastening device. Furthermore, the weight of the fastening device can be reduced by eliminating further components.

Furthermore, the spacing of the second end from the fastener ensures that the force flow caused by the mutual support of the structure does not coincide with the location where the fan is connected to the fastener. Thus, an interruption or negative influence on the force flow can thus be prevented. The spatial spacing is to be understood to mean that the connection point overlaps neither completely nor partially with the fastener. A separation of functions can be achieved in a simple structural manner. The rigidity and stability of the structure of the fastener is achieved through the mutual support of the second end at the connection point of the adjacent support element. The connection between the fan and the fastener is achieved solely via the fastener.

According to a preferred embodiment, a provision is made that the fastener is arranged between the second end and the connection point. This results in three support points on each of the support elements. The first support point is the first end of the support element where it attaches to the carrier structure. The second support point is located at the connection point where the second end connects to the adjacent support element. The third support point is located at the second end, where a connection to an adjacent support element is also established. By virtue of the fact that the fastener is arranged between the connection point and the second end, the forces acting on the support elements via the fastener during operation of the fan, can be absorbed evenly. This arrangement achieves a particularly high level of rigidity, that has an advantageous effect, particularly during operation, due to lower vibrations.

According to a preferred embodiment, four support elements are provided that are respectively connected to one another at an angle of 90°. Thus, the support elements form a rectangular, preferably a square, support structure. The rectangular structure has proven to be advantageous because it enables a suitable compromise to be achieved between the complexity of the structure and stability.

It is especially advantageous if at least two first support elements have a receiving element. At least two second support elements have a bearing element at the second end. The receiving element is designed to receive the bearing element. The bearing element is preferably formed by a projection at the second end. It can rest against the top of the adjacent support element, particularly at the connection point of the adjacent support element. This provides support in the direction of the axis of rotation of the attached fan. The receiving element is preferably designed to limit the movement of the bearing element in two additional spatial directions. Thus, the fastening device is stabilized even further.

Furthermore, it is advantageous if the first support element, with the receiving element, and the second support element, with the bearing element, are arranged alternately along the rectangular support structure. Thus, this ensures that an additional support is achieved at two points of the rectangular support structure through the interaction of the bearing element with the receiving element. Preferably, each support element can also be preferably designed with a bearing element at the second end and a receiving element at the connection point. This means that additional support can be achieved in four places.

According to another preferred embodiment, the support element has two legs that are arranged substantially at right angles to one another. In the context of the present disclosure, a rectangular arrangement is to be understood as an arrangement at an angle between 70° and 110°, more preferably at an angle between 80° and 100°. The angle relates to the main direction of extension of the respective legs. By virtue of the first leg, which preferably extends in the direction of the axis of rotation of the fan that is being used, the fastener can be spaced in precisely this direction from the first end of the support element. The connection to the carrier structure is established, thereby creating sufficient space for the rotating rotor blades. Accordingly, the second legs are arranged on a plane orthogonal to the axis of rotation of the attached fan. This results in an ideal fastening position to fasten the motor flange via the fastener.

Preferably, the support element is formed from a planar element with a base surface. A carrier section of the first leg is angled relative to the base surface. A support section of the second leg is angled relative to the base surface. The use of planar elements, particularly sheet metal parts, makes inexpensive production possible. A starting component for the support element can be produced by punching, for example. A support section adjoining the base surface and a carrier section can be produced by bending the starting component. The support section is formed through bending at an angle of approximately 90°. The beam section is formed through bending at an angle of 30 to 60°.

It is also advantageous if the fastener is embodied as part of the support section. The fastener is preferably a bore through which the motor flange can be connected to the fastener by a screw. The arrangement of the fastener on the support section means that additional elements can be dispensed with. More preferably, the support section can also be adapted to the geometry of the annular motor flange. According to a preferred embodiment, the support element is reinforced by a second planar element in order to reinforce at least subsegments. The connection between the planar elements can be established, for example, by rivet or adhesive connections. The reinforcement of the subsegments has the advantage that inexpensive and weight-saving stabilization takes place only at the required points.

According to the basic idea of the disclosure, a ventilation system is also proposed that comprises a fan and a fastener to fasten the fan to a carrier structure. A drive motor of the fan is connected via a motor flange to the fastener. This is the fastening device according to the disclosure.

The disclosure is explained in greater detail below on the basis of preferred embodiments and with reference to the drawings.

### DRAWINGS

The drawings described herein are for illustrative purposes only of selected embodiments and not all possible implementations and are not intended to limit the scope of the present disclosure.

FIG. 1 is a schematic perspective view of a ventilation system with a fastening device and a fan;

FIG. 2 is a side elevation view of a ventilation system with a fastening device and a fan; and

FIG. 3 is a top plan view of a ventilation with a faster and a fan.

### DETAILED DESCRIPTION

Insofar as directional information such as “up” or “down” is given below for better understanding, they correspond to the direction following from the orientation of the figures on the sheet.

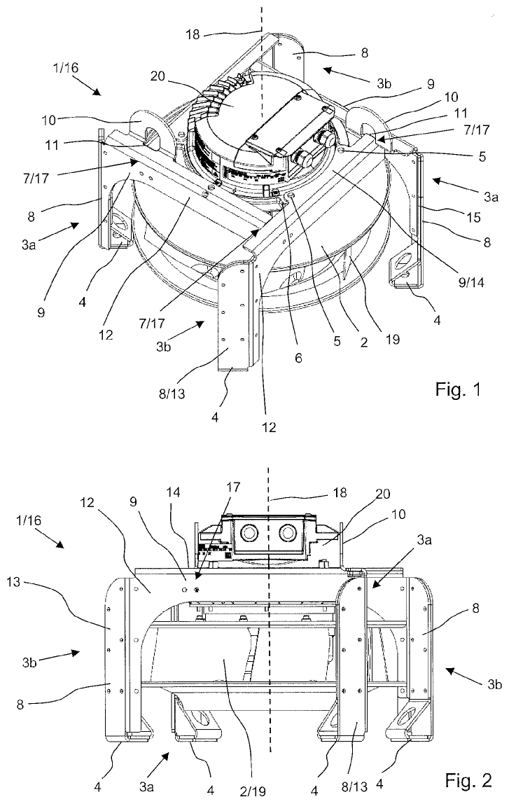

FIG. 1 shows a ventilation system 16 with a fastening device 1 and a fan 2.

The fastening device 1 includes four support elements 3a and 3b that can be connected at a first end 4 to a carrier structure (not shown). The support elements 3a, 3b are supported at their respective second end 7 on an adjacent support element 3a, 3b. For this purpose, a section of the base surface 12 is preferably angled so that it rests flat against a connection point 17 of the adjacent support element 3a, 3b. The connection between the two support elements 3a, 3b can be preferably established by a rivet and/or adhesive connection.

The fan 2 fastened to the fastening device 1 includes rotor blades 19, to generate an air flow, a drive motor 20, and a motor flange 6. The motor flange 6 is fastened to the fastening device 1 by a fastener 5.

The four support elements 3a and 3b are largely identical. They each have a first leg 8 and a second leg 9. The main orientation of the first leg 8 corresponds to the direction of an axis of rotation 18 of the fan 2. The main orientation of the second leg 9 is orthogonal to the first leg 8. The support elements 3a and 3b are made from a planar element, preferably from sheet metal. The support elements 3a and 3b have the base surface 12, a carrier section 13, and a support section 14. The carrier section 13 and the support section 14 are angled relative to the base surface 12, thereby achieving a stabilizing effect.

The carrier section 13 is part of the first leg 8. It is angled at the first end 4 so that it can be fastened to the carrier structure via a fastener, preferably a bore.

The support section 14 is part of the second leg 9. It is preferably angled at a right angle relative to the base surface 12. Thus, the surface of the support section 14 is oriented on a plane orthogonal to the axis of rotation 18.

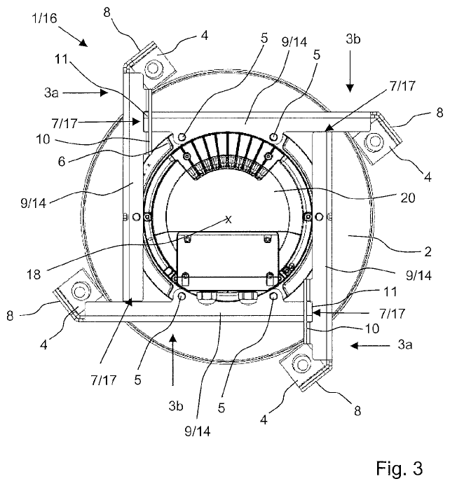

In the exemplary embodiment according to FIG. 1, the support elements 3a and 3b differ from one another with respect to the following features. The second support element 3b has the fastener 5, via which, the motor flange 6 is connected to the second support element 3b. In order to ensure that the two bores that form the fastener 5 lie flush over one another in alignment with the bores of the motor flange 6, the support section 14 is preferably adapted to the ring shape of the motor flange 6. Alternatively, or in addition, it is of course possible to arrange the fastener 5 on the first support element 3a. Furthermore, the second support element 3b has a bearing element 11 that is preferably formed by a partial section of the second end 7. The bearing element 11 rests on the support section 14 of the adjacent first support element 3a, see also FIG. 3.

In contrast to the second support element 3b, the first support element 3a has a receiving element 10. It is designed to receive the bearing element 11 of the adjacent second support element 3b. The receiving element 10 is preferably formed by a U-shaped section that is preferably bent upward at right angles relative to the support section 14. The recessed interior of the U-shaped section can support the bearing element 11 so that it limits the movement, in addition to the limitation by the support section 14 in two additional spatial directions. This configuration only allows the bearing element 11 to move upward, which simplifies assembly. Because the bearing element 11 is preferably associated with the second support element 3b, the force acting on the support element 3b via the fastener 5, can also be better absorbed by the adjacent first support element 3a, which makes efficient mutual support possible.

It is also shown in FIG. 1 that the support elements 3a and 3b are reinforced in certain sections by a second planar element 15. The first and the second planar element 15 preferably include the same starting material. The base surface 12 and the carrier section 12 are preferably reinforced, but the support section 14 is not. The connection between the first planar element and the second planar element 15 is preferably made at points by a rivet and/or adhesive connection.

FIG. 2 shows the ventilation system 16 with the fastening device 1 and the fan 2 in a side view. Since the exemplary embodiment is identical to that in FIG. 1, only the features that can be recognized more advantageously in this illustration will be discussed below.

The fan 2 shown is a radial fan. The rotor blades 19 are arranged below the rectangular support structure that is formed by the four second legs 9 and their support sections 14. The first legs 8 advantageously extend so far downward in the direction of the axis of rotation 18 that they protrude beyond the lower end of the fan 2. This enables sufficient distance from the carrier structure to be created, lest the carrier structure adversely affect the flow behavior. Furthermore, the carrier sections 13 are angled in the direction relative to the base surface 12 where the rotor blades 18 are also oriented. This ensures that the direction of flow preferably coincides with the alignment of the carrier section 13. Thus, fluid mechanical losses can thus be reduced.

Furthermore, FIG. 2 shows that the drive motor 20 protrudes upward at least partially beyond the rectangular support structure. This ensures good accessibility to attach power supply lines, for example.

FIG. 3 shows the ventilation system 16 with the fastening device 1 and the fan 2 in a plan view. Here, too, only the features that can be recognized more advantageously in this illustration are described.

The, preferably, square support structure is formed by the second legs 9 and their support sections 14, seen in FIG. 3. Furthermore, FIG. 3 shows the spacing of the first end 4 from the connection point 17 in the direction of a plane that is oriented orthogonally to the axis of rotation 18. This enables the rotor blades 19 to be accommodated despite the relatively large diameter. At the same time, the motor flange 6, with the smaller radius compared to the rotor blades 19, is able to be received due to the square support structure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-10. (canceled)

11. A fastening device for fastening a fan to a carrier structure, comprising:
at least two support elements, each of the at lease support elements connected at its first end to the carrier structure, the at least two of the support elements have a fastener for fastening a fan;
the support elements are connected at their second end to the adjacent support element, so that the support elements support one another;
the fasteners are spaced apart from a connection point where the second end is connected to the adjacent support element;
the support element has two legs that are arranged substantially at right angles to one another; and
the support element is formed from a planar element with a base surface, a carrier section of the first leg angled relative to the base surface, and a support section of the second leg angled relative to the base surface.

12. The fastening device as set forth in claim 11, wherein the fastener is arranged between the second end and the connection point.

13. The fastening device as set forth in claim 11, wherein four support elements are provided that are respectively connected to one another at an angle of 90°, so that the support elements form a rectangular support structure.

14. The fastening device as set forth in claim 13, wherein at least two first support elements have a receiving element and at least two second support elements have a bearing element at the second end, the receiving element being designed to receive the bearing element.

15. The fastening device as set forth in claim 14, wherein the first support element, with the receiving element, and the second support element, with the bearing element, are arranged alternately along the rectangular support structure.

16. The fastening device as set forth in claim 11, wherein the fastener is embodied as part of the support section.

17. The fastening device as set forth in claim 11, wherein the support element is reinforced by a second planar element in order to reinforce at least subsegments.

18. A ventilation system, comprising a fan and a fastening device for fastening the fan to a carrier structure as set forth in claim 11, and a drive motor of the fan is connected to the fastening device via a motor flange.
